(19) United States
(12) Patent Application Publication
(10) Pub. No.: US 2024/0368506 A1
(43) Pub. Date: Nov. 7, 2024

(54) Manufacturing a Non-Alcoholic Distilled Spirit and Functional Ingredient

(71) Applicant: Robert Brocia, Bronxville, NY (US)

(72) Inventor: Robert Brocia, Bronxville, NY (US)

(21) Appl. No.: 18/143,065

(22) Filed: May 4, 2023

Related U.S. Application Data
(60) Provisional application No. 63/473,112, filed on May 3, 2022.

(51) Int. Cl. C12G 3/025

(52) U.S. Cl. CPC C12G 3/025; C12G 2200/15

(57) ABSTRACT

Compositions containing monoamine oxidase inhibitors derived from agave-based drinks are disclosed, along with methods to alter their inhibitory activity.

### CROSS-REFERENCE TO RELATED APPLICATIONS

This application claims priority to U.S. Provisional Application No. 63/473,112 filed May 3, 2022, the contents of which are incorporated herein by reference in their entirety.

### BACKGROUND ART

U.S. Pat. No. 10,195,163 describes the production of compositions containing significant concentrations of inhibitors of MAO A and MAO B from tequilas and from pulque. Reverse osmosis and spinning cone column technologies are described as techniques for removing alcohol while preserving the activity of these inhibitors.

U.S. Patent Application No. 2018/0296629 published 18 Oct. 2018 describes improved methods to remove alcohol from the distillates.

U.S. patent application Ser. No. 16/696,898 filed Nov. 26, 2019, discloses the effect of MAO B inhibition on the consumers of tequila.

U.S. Pat. No. 4,612,196 filed Aug. 23, 1984, discloses a low alcoholic beverage production method using reverse osmosis.

Recently, there have been introduced brands of formulated non-alcoholic beverages that attempt to act as a replacement for their alcoholic counterparts. For example, the Ritual company produces distilled spirit-like products to replace tequila, whiskey, and others. However, the Ritual products are not truly distilled spirits or made from distilled spirits, but more a combination of flavor compounds.

Another product is produced by Seedlip, which is stated by the company to be a non-alcoholic distilled spirit. However, the Seedlip products are not attempting to recreate non-alcoholic version of a known distilled spirit, it is believed the company distils off the ethanol after performing ethanolic extractions on plant-based material and incorporates extracts into a water-based beverage. There is apparently no fermentation-derived essence in the Seedlip products.

Although dealcoholized beer and wine are well known and commercially available, there does not appear to be any actual distilled spirit products available without alcohol. Beer, wine and kombucha are readily available without alcohol, however, the common theme seems to be the unavailability of fermented dealcoholized products in which the starting alcohol by volume (ABV) is greater than approximately 15%. The dealcoholization processes used in the industry include reverse osmosis (RO) and spinning cone column (SCC). Both have technical limitations that involve limits for the removal of ethanol. For example, wine and beer are relatively low in alcohol content (less than 20% ABV) and may be put through either process without dilution. Distilled spirits at or above 40% ABV cannot be processed at full strength by RO due to membrane/ethanol incompatibility. RO requires the spirit to be diluted below 20% ethanol ABV. High ethanol concentration will disrupt membrane integrity, but with dilution the resulting dealcoholized product would lose its original organoleptic qualities.

In the case of spinning cone column (SCC), using a feed source at high alcohol concentration produces explosive ethanol vapors that must be considered. SCC initially strips aroma compounds with ethanol, which must be separated through chromatographic methods, such as Flavourtech's Resin Adsorbing Column.

There does not appear to be a non-alcoholic distilled spirit available with the characteristics and desirable qualities of the present invention. The present invention is derived from a fermented mash identical to the alcoholic counterpart, such as whiskey, rum, tequila, etc. at an ethanol by volume concentration equal to or above 40%. The present invention retains the original organoleptic qualities of the starting distilled spirit and provides the experiential effects from MAO inhibition.

### DISCLOSURE OF THE INVENTION

In one aspect, the present invention is based on the recognition that the ratio of the inhibitors contained in agave derived distillates for inhibition of MAO B as compared to inhibition of MAO A is significant. It is now understood that the quality of either the distillate itself used as a beverage or of a derivative relatively nonalcoholic form thereof is at least in part determined by the ratio of inhibitors of monoamine oxidases A and B.

Thus, the invention is directed to a method to improve the quality of a beverage which is tequila or mezcal or a drink with reduced alcohol content derived therefrom which method comprises altering the ratio of inhibitor of MAO B to inhibitor of MAO A contained therein to increase this ratio in favor of MAO B inhibition.

In another aspect, the invention is directed to a method to create a low or non-alcoholic distilled spirit by a non-dilution process that retains volatile components other than ethanol.

In yet another aspect, the present invention is directed to a method to create a low or non-alcoholic distilled spirit by a non-dilution process that retains volatile components other than ethanol, in which the volume of ethanol removed is replaced by a volume of similarly dealcoholized agave-derived fermented spirit with a high ratio of MAO B to MAO A inhibition.

Thus, the invention is directed to a method to create a desirable dealcoholized distilled spirit by processing a greater than 20% ABV distilled spirit beverage without dilution by a method that removes ethanol while retaining other components comprising the flavor profile of the distilled spirit and providing a functional ingredient derived from dealcoholized fermented agave-based sources.

In another embodiment, the present invention is a dealcoholized distilled spirit created by processing a greater than 20% ABV distilled spirit beverage without dilution by a method that removes ethanol while retaining other components comprising the flavor profile of the distilled spirit and providing a functional ingredient of MAO inhibitory activity derived from dealcoholized fermented agave-based sources. The MAO inhibitory activity of which is of a MAO B to MAO A ratio that is greater than 1.

Beverages that are thus obtained and methods to treat depression and Parkinson's disease and to enhance cognition by providing these beverages are also part of the invention.

### MODES OF CARRYING OUT THE INVENTION

With respect to the first aspect of the invention, the quality of a beverage is improved by altering the ratio of inhibitor of MAO B to inhibitor of MAO A contained therein to increase this ratio in favor of B.

It is understood that MAO inhibitors are used to treat depression, inhibitors of MAO B are also used to treat Parkinson's disease. Increased MAO B activity is associated with aging and cognitive decline in humans. MAO B catalyzes the metabolism of phenylethylamine (2-phenylethylamine, PEA), a neurotransmitter classified as a trace amine with effects similar to amphetamine that is believed to increase the concentration of serotonin and dopamine in the synaptic cleft by inhibiting re-uptake of those neurotransmitters. Trace amines are present in significantly lower concentration than other functional amine neurotransmitters, but PEA has a potent effect by its mechanism of action that involves binding to a G protein coupled receptor of the type that is also activated by amphetamine. Metabolic breakdown of PEA is thus a depressant and hydrogen peroxide, a by-product resulting from MAO B activity, contributes to cognitive decline.

It is further understood that MAO B inhibition increases levels of phenylethylamine, which increases levels of serotonin and dopamine for positive experiential effects. Thus, enhanced levels of MAO B inhibitor provide the ability to improve cognition.

Thus, in one illustrative embodiment using the example of tequila, ethanol is removed to a desired level with simultaneous removal of MAO A inhibitors and retention of MAO B inhibitors resulting in an effective concentration and desired ratio of inhibitors MAO A/MAO B to produce the desired experiential effect for the user. A desirable experiential effect is mood elevation or a feeling of well-being, which is currently undefined with respect to tequila as that contains typically 40% ethanol by volume, masking the effects of MAO inhibitors. Although tequila has the same ethanol concentration as other distilled spirits, the experiential effect is noticeably different as confirmed by anecdotal information found online. For example, the description by the founders of celebrity tequila, Casamigos, includes this statement about formulating the brand “ . . . typically we drink it straight or on the rocks—that we could drink all day long and not be hungover in the morning.” The question becomes why it can be consumed “all day long,” but not be followed by a hangover. This is due to the presence of MAO inhibitors, which Table 3 shows the ratings of Don Julio tequila correlate with MAO B inhibition. The converse is also true as indicated by the Don Julio 70^{th}, which is produced from the Añejo with a significant loss of MAO B inhibitory activity (26% inhibition down to 6%). Consequently, ‘likes’ fall from 141 to 70. Processing spoils the añejo tequila's ‘likability’ by decreasing MAO B inhibition.

TABLE 1

| | % Inhibition | % Inhibition | |
|---|---|---|---|
| Brand | MAO A | MAO B | Likes |
| Don Julio 1942 | 18 | 35 | 290 |
| Don Julio Añejo | 10 | 26 | 141 |
| Don Julio Reposado | 18 | 22 | 113 |
| Don Julio Blanco | 9 | 8 | 106 |
| Don Julio 70th | 12 | 6 | 70 |

Table 1 provides a basis to suggested that the MAO inhibitors present in agave derived spirits are indeed bioactive. The inhibitor dependent “likes” are as would be expected with the prevention of metabolism of biogenic amines. The brain's reward system associated with increased levels of dopamine appears to be a factor with consumer response to MAO B inhibition.

The invention is a method to create a low or non-alcoholic distilled spirit by a non-dilution process that retains volatile components other than ethanol. In the case of whiskey or other distilled spirit, conventional dealcoholization methods cannot provide an acceptable result, for in the case of reverse osmosis the spirit must be diluted to an ethanol concentration below approximately 20% or to a level that will not harm the semipermeable RO membrane. Similarly, spinning cone column methods require special consideration if the feed is at high ethanol concentration due to generation of explosive vapors. In addition, SCC methods strip flavor compounds along with ethanol.

A preferred method of alcohol removal according to the invention is by distillation alone, without consideration of distillate heads, tails, or hearts. The starting material already represents the desirable “heart” fraction because in the production of the distilled spirit the undesirable components have already been rejected. According to the invention, distillation is performed with either conventional distillation or fractional distillation at atmospheric pressure or below. In general, the system will include a boiling flask to which is attached a column that includes contacting plates, such as bubble cap plates, in which vapor will travel up the column and liquid phase travels down back to the boiling flask. The number of plates will depend on the complexity of the components and ethanol concentration in the feed spirit. Discrete volatile compounds in the feed spirit may have boiling points at significantly higher temperatures than the temperature of the distillation, but vaporization of compounds will depend on the relationship the volatiles have with the matrix rather than their reported boiling point as a pure compound.

In a further embodiment of the invention, a drink containing MAO inhibitors is produced from a feedstock of a distilled agave-derived beverage at 40-60% ethanol by volume (ABV). The feed is treated with a deep eutectic solvent (DES) comprised of glycerol and choline chloride at a molar ratio of approximately 2:1. The DES breaks the azeotrope that normally is associated a mixture of ethanol and water, the alcohol/water azeotrope complicates separation of ethanol since it has a boiling point less than that of ethanol alone. In addition, it is unclear how the molecular interactions of other components present in agave spirits may influence volatilization of desired flavor compounds. It has been reported in the literature that a water/ethanol mixture may be resolved by breaking the azeotrope with certain conditions that include distillation under sub atmospheric pressures. After the alcoholic feed is treated with a DES, including glycerol/choline chloride, and added to the boiling flask of a distillation apparatus, evaporation of ethanol is possible.

Furthermore, a DES comprised of glycerol/choline chloride has a beneficial effect on a drink after alcohol removal with glycerol normally added to tequila for mouthfeel and choline a known essential nutrient. It may also be advantageous to proceed with the distillation of ethanol at a lower temperature than may be achieved without a DES as analysis of the MAOI profiles of distilled agave-derived spirits shows a decrease in MAO B inhibition related to distillation temperature and time. For example, Don Julio añejo tequila when converted to the 70^{th} version undergoes a 3^{rd} distillation, which lowers MAO B inhibition (it is noted that filtration may also be a factor). In preparing samples of dealcoholized tequila we have noticed a loss of MAO B inhibitory activity when harsher conditions are used.

### EXAMPLE 1

One preferred method to prepare a nonalcoholic beverage according to the invention is treating a 30-80% ABV spirit with a DES, such as choline chloride-glycerol at a molar ratio of 1:2. Depending upon the components comprising the spirit, a weight/weight amount of DES includes 1-15%. For some dealcoholizing steps a vacuum fractional distillation apparatus is used with pressures from 90 to 760 Torr. Temperature at the boiling flask will be adjusted according to pressure where boiling for ethanol vaporization may occur above atmospheric pressure and volatilization of desired flavor compounds is reduced.

### EXAMPLE 2

Some known MAO inhibitors are non-specific or cross-react with both MAO A and B, however, the inhibitors present in tequila are specific inhibitors for either form of monoamine oxidase. This is seen in the activity assay results comparing Don Julio Añejo (DJA) and Casa Dragones (CD) brands.

In recognition of the importance of a ratio high in levels of MAO B inhibition relative to MAO A inhibition, is the production of a high MAO B tequila according to the following method:
a) The agave material comprised of complex sugars is turned into a slurry by a diffuser and acid hydrolysis is performed with sulfuric acid followed by thermal hydrolysis in an autoclave. Traditional methods of hydrolysis involve thermal treatment of complex sugars in which, it is believed a multitude of reactions occur including the formation of Maillard compounds.
d) The simple sugars are fermented in line with traditional methods.
e) Distillation is performed on a fractionating column x2.

The production of a high MAO B tequila according to the invention involves chemical hydrolysis of the complex sugars.

Table 2 shows inhibitory activity in DJA and CD tequilas and the effect of controlled chemical hydrolysis of the complex sugars compared to traditional thermal hydrolysis.

TABLE 2

| | % Inhibition MAO A | % Inhibition MAO B |
|---|---|---|
| Casa Dragones | 9 | 54 |
| Blanco | | |
| Don Julio Anejo | 21 | 71 |

### EXAMPLE 3

The effect terpenes on MAOI activity in tequila was evaluated in the experiment from Table 3. Terpenes were added to 40% ethanol and tequila (40% ABV) at 0.5%. (v/v) and assayed for MAO inhibitory activity. Twenty-one other terpenes were assessed for influencing MAOI activity with little or no effect. Significant effects on the MAO inhibitory profile of tequila after terpene treatment is not result from the terpene acting alone, but in concert with the other components present in tequila. Thus, treatment of tequila to alter the MAO inhibitor profile without the addition of inhibitor is demonstrated by the experiment, and provides a useful method to enhance the perceived quality of tequila and other fermented agave-derived beverages.

TABLE 3
Don Julio Añejo (DJA) or 40% ethanol (ETOH) were spiked
with terpenes and assayed for MAO A and MAO B inhibitory activity.

| Δ % Inhibition MAO A | | Δ % Inhibition MAO B |
|---|---|---|
| (DJA + terpene) − | | (DJA + terpene) − |
| (ETOH + terpene) | Terpene | (ETOH + terpene) |
| 1 | eugenol | 8 |
| 0 | citral | 2 |
| 4 | Geramol | 9 |
| 1 | terpinolene | 9 |
| 7 | terpineol | 18 |
| 5 | β-myrcene | 11 |
| 9 | valencene | 20 |
| 8 | limonene | 10 |

Dealcoholized tequila is a novel, specific and reversible MAO inhibitor with usefulness as a functional ingredient for food and beverage. Following dealcoholization, the MAO inhibitor may be added to a cola drink, for example, at 50 ml to 250 ml cola. The collection of compounds in table 6 are used as synergistic ingredients to the MAOIs when it is used as a functional ingredient.

For example, a cola drink, as an enhanced beverage will contain compounds chosen from Table 4 in addition to the agave derived functional ingredient. The compounds are classified as GRAS by FDA and fully characterized flavor compounds. They are added to 1 liter of MAO fortified beverage at an amount of 0.1-40 mg of compound. The amount of each compound for beverage is regulated by FDA.

The experiential effect of mood elevation is achieved with a MAO B-to-MAO A inhibition ratio of greater than 1.

A formulation for agave derived beverages that provides enhanced MAO B inhibition is prepared by adding one or more compounds from Table 6 at 0.1-40 mg per liter of beverage.

### EXAMPLE 4

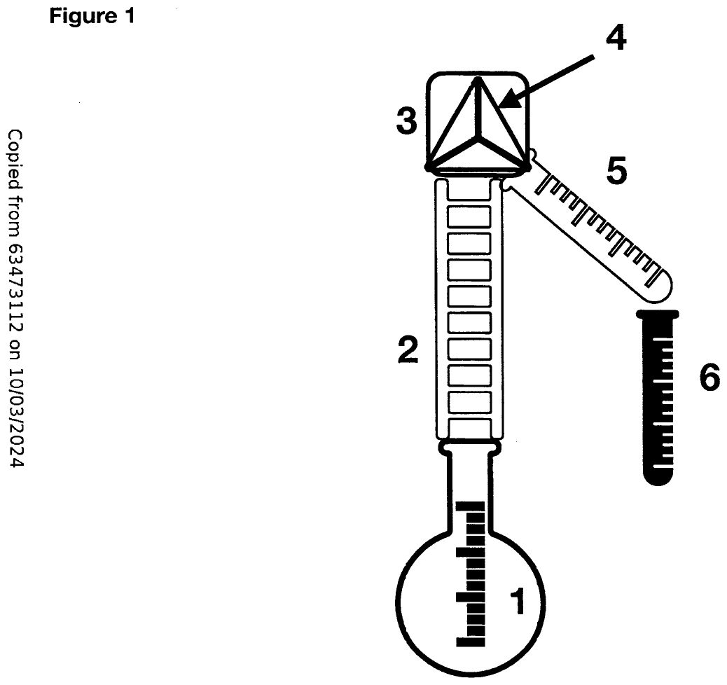

In another embodiment, dealcoholization is accomplished with a source comprised of a fermented mash from an agave-derived sugars that undergoes two distillations (i.e., tequila, according to the Mexican CRT for tequila; or following other traditional methods developed for bacanora, sotol or mezcal) the resulting distillates from the second distillation are approximately 55% ABV or alternatively adjusted to approximately 40% ABV, as in the bottled distilled spirit. Distilled agave spirit is provided in bulk quantities from distillers at 55% ABV and bottled spirits are typically supplied at 40% ABV. Each provides a good source of agave-derived functional compounds with MAO inhibitory activity in ethanol/water solution. To remove ethanol while preserving the flavor and functional compounds, the agave spirit is added to a boiling flask 1 of the distillation system (FIG. 1). The system is fitted with column 2, that includes vapor/liquid contactors (i.e., bubble plates, raschig rings or glass beads) or a vigreux or snyder column; with a reflux apparatus 3, and valve 4 at the top of the column. Distillation is begun by heating the boiling flask to obtain a state of reflux with vapor traveling up through the column plates, packing or baffles and liquid returning to the boiling flask of the system. The system is provided with a temperature sensor at the top of the column to monitor fluctuations in temperature that signal collection of the distillate.

With vapor/liquid reflux established the valve is opened to direct the vapor to a water-cooled condenser 5 and collection vessel 6 for fraction #1, after a drop in temperature the next fraction is recovered at a higher temperature as fraction #2. The next fraction is predominately the azeotrope of ethanol and water, which is collected as fraction #3, and remaining in the boiler is water with less volatile compounds.

At atmospheric pressure the boiling flask temperature is kept below 110° C. At reduced pressure, such as 60 Torr, the azeotrope of ethanol and water boils at room temperature and distillation is stopped to prevent water from distilling at the highest temperature. Depending upon the alcohol content desired fraction #1 may be added back to the boiling flask.

1. A beverage comprised of MAO inhibitors which is tequila or mezcal or a drink with reduced alcohol content produced therefrom, in which said beverage is derived from a fermented mash comprised of non-thermally hydrolyzed complex sugars.

2. The beverage of claim 1 wherein said non-thermally hydrolyzed complex sugars includes chemical hydrolysis.

3. A method to improve the quality of a beverage which is tequila or mezcal or a drink with reduced alcohol content produced therefrom, which method comprises altering the ratio of inhibitors of monoamine oxidases A and B (MAO A and MAO B) contained therein to increase the ratio of inhibitor of MAO B to that of MAO A or comprises enhancing the concentration of inhibitor of MAO B.

4. The method of claim 3 wherein the improved quality is the experiential perception of a person consuming said beverage.

5. The method of claim 3 wherein said altering comprises the addition of at least one of the compounds at 0.5% (V/V) selected from the list; eugenol, citral, Geramol, terpinolene, terpineol, β-myrcene, valencene, limonene.

6. The method of claim 3 wherein said altering comprises adding an inhibitor of MAO B isolated from tequila, mezcal or drink with reduced alcohol produced therefrom to said beverage.

7. A beverage prepared by the method of claim 5.

8. A beverage prepared by the method of claim 5 in which the addition of one or more compounds is at 0.1-40 mg per liter of beverage.

9. A method to selectively remove ethanol from a distilled spirit by:
a) adding a deep eutectic solvent to said distilled spirit creating a mixture;
b) subjecting said mixture to distillation at 90 to 760 Torr producing distillate and retained fractions;
c) collecting said 90 torr distillate;
d) combining said collected distillate with said retained fraction to produce a reduced alcohol spirit.

10. A method to selectively remove ethanol from a 40 to 55% alcohol by volume distilled spirit comprising the following steps:
a) Adding said distilled spirit to the boiling flask of a distillation apparatus fitted with a column containing vapor/liquid contacting and reflux means;
b) Providing a state of vapor reflux in said distillation apparatus;
c) Directing a portion of said refluxing vapor to the condensing means of said distillation apparatus;
d) Collecting a first fraction of distillate;
e) Combining said first fraction to the retained fraction producing a reduced ethanol spirit.
